(19) United States
(12) Patent Application Publication
(10) Pub. No.: US 2025/0385356 A1
(43) Pub. Date: Dec. 18, 2025

(54) SECONDARY BATTERY

(71) Applicant: SAMSUNG SDI CO., LTD., Yongin-Si (KR)

(72) Inventor: Taewoong JANG, Yongin-Si (KR)

(21) Appl. No.: 18/933,981

(22) Filed: Oct. 31, 2024

(30) Foreign Application Priority Data
Jun. 12, 2024 (KR) 10-2024-0076655

(51) Int. Cl. H01M 50/188; H01M 50/109; H01M 50/153; H01M 50/169; H01M 50/474; H01M 50/559

(52) U.S. Cl. CPC H01M 50/188; H01M 50/109; H01M 50/153; H01M 50/169; H01M 50/474; H01M 50/559

(57) ABSTRACT

A secondary battery including: a case defining an open area a first side, the open area being configured to accommodate an electrode assembly; a cap plate seated on and coupled to the open area of the case and having a through-hole; a terminal plate configured to include a body and an insertion portion extending through the through-hole of the cap plate; and an insulating layer between the cap plate and the body of the terminal plate, wherein the cap plate includes a central portion and a peripheral portion provided on a periphery the central portion, the peripheral portion being configured to be coupled to the first side of the case, and wherein the peripheral portion has a greater thickness than the central portion.

### CROSS REFERENCE TO RELATED APPLICATION

The present application claims priority to and the benefit of Korean Application No. 10-2024-0076655, filed on Jun. 12, 2024, in the Korean Intellectual Property Office, the entire disclosure of which is incorporated by reference herein.

### BACKGROUND

### 1. Field

Aspects of the present disclosure are related to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In an example in which components of a secondary battery are fitted together, welding is generally used. However, in the process of welding the components of the secondary battery, weld failure may frequently occur. In such examples, a short circuit may occur in the secondary battery. In an example in which two materials having different polarities in the secondary battery come into electrical contact and an internal short circuit occurs, the temperature of the secondary battery may rise rapidly and, in severe cases, cause a fire.

The above information disclosed in this Background section is for enhancement of understanding of the background of the present disclosure, and therefore, it may contain information that does not constitute related (or prior) art.

### SUMMARY

Aspects of embodiments of the present disclosure are directed to a secondary battery configured to overcome the above-described problems.

These and other aspects and features of the present disclosure will be described in or will be apparent from the following description of embodiments of the present disclosure.

According to some embodiments of the present disclosure, there is provided a secondary battery including: a case defining an open area a first side, the open area being configured to accommodate an electrode assembly; a cap plate seated on and coupled to the open area of the case and having a through-hole; a terminal plate configured to include a body and an insertion portion extending through the through-hole of the cap plate; and an insulating layer between the cap plate and the body of the terminal plate, wherein the cap plate includes a central portion and a peripheral portion provided on a periphery the central portion, the peripheral portion being configured to be coupled to the first side of the case, and wherein the peripheral portion has a greater thickness than the central portion.

In some embodiments, the peripheral portion includes a bend portion which is a portion of the cap plate bent in a height direction of the peripheral portion and a protrusion extending beyond the central portion.

In some embodiments, a portion at which the central portion and the peripheral portion of the bend portion are connected is bent at an angle of 90 degrees or more.

In some embodiments, the terminal plate is joined to the cap plate such that the insertion portion faces the electrode assembly.

In some embodiments, the insertion portion is provided on a first surface of the body, and the terminal plate is joined to the cap plate such that a second surface of the body opposite the first surface faces the electrode assembly.

In some embodiments, the case includes a seating portion on the first side of the case, the seating portion having a stepped portion provided in a direction from an outer surface to an inner surface, and the peripheral portion of the cap plate is seated on the seating portion.

In some embodiments, the seating portion includes a portion of an outer surface of the case protruding in a radial direction of the case.

In some embodiments, the outer surface of the seating portion is flush with an outer surface of the case in a height direction of the case.

In some embodiments, the seating portion has a thinner sidewall than a sidewall of the case.

In some embodiments, the case is joined to the cap plate by welded contact portions between the case and the cap plate.

In some embodiments, the peripheral portion includes a bend portion which is a portion of the cap plate bent in a height direction of the peripheral portion, and the bend portion of the peripheral portion is seated on the seating portion.

In some embodiments, the peripheral portion includes a protrusion extending beyond the central portion in a height direction of the peripheral portion, and the protrusion of the peripheral portion is seated on the seating portion.

In some embodiments, the peripheral portion further includes a curved portion which is a portion of the protrusion bent in a direction parallel to the central portion of the cap plate, and the curved portion of the protrusion is seated on the seating portion.

In some embodiments, at least a portion of the insulating layer is between the cap plate the body of the terminal plate.

In some embodiments, the peripheral portion includes a bend portion which is a portion of the cap plate bent in a height direction of the peripheral portion, and at least a portion of the insulating layer is on the bend portion of the cap plate.

In some embodiments, the peripheral portion includes a protrusion extending beyond the central portion in a height direction of the peripheral portion, and at least a portion of the insulating layer is next to an inner surface of the protrusion of the cap plate.

In some embodiments, at least a portion of the insulating layer is to surround the body of the terminal plate.

In some embodiments, the central portion of the cap plate has a thickness of 50 to 100 μm, and the peripheral portion has a thickness of 150 to 200 μm.

In some embodiments, a thickness of the peripheral portion of the cap plate is 1.5 to 3 times a thickness of the central portion.

In some embodiments, the peripheral portion of the cap plate has a width of 100 μm or more.

According to various embodiments of the present disclosure, damage to the electrode assembly and/or the electrode tab that would otherwise be caused by welding in a secondary battery may be prevented or the likelihood thereof may be substantially reduced. In particular, even when the thickness of the central portion of the cap plate is reduced, predetermined weld regions may be provided from the peripheral portion and the first side of the case to reduce (e.g., minimize) welding defects.

According to some embodiments of the present disclosure, the insulating layer disposed between the cap plate and the terminal plate may prevent foreign matter from being inserted between the cap plate and the terminal plate, thereby preventing or substantially reducing the likelihood of a short circuit. In addition, even in the case that the thickness of the peripheral portion of the cap plate is greater than the thickness of the central portion of the cap plate, the insulating layer may be extended to prevent a short circuit or substantially reducing the likelihood thereof.

According to some embodiments of the present disclosure, the secondary battery may have increased energy density while preventing or substantially reducing the likelihood of a short circuit.

The secondary battery according to some embodiments of the present disclosure may be accommodated in a limited space because the secondary battery has no outwardly protruding portion. In addition, the secondary battery may be less susceptible to damage from external objects due to the lack of protruding portions.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view of a secondary battery according to some embodiments of the present disclosure;

FIG. 2 illustrates a cross-sectional view of a cap assembly according to some embodiments of the present disclosure;

FIG. 3 illustrates a cross-sectional view of a cap assembly according to some other embodiments of the present disclosure;

FIG. 4 illustrates a cross-sectional view of a cap assembly according to some other embodiments of the present disclosure;

FIG. 5 illustrates a partial cross-sectional view of a secondary battery according to some embodiments of the present disclosure;

FIG. 6 illustrates a partial cross-sectional view of a secondary battery according to some other embodiments of the present disclosure;

FIG. 7 illustrates a partial cross-sectional view of a secondary battery according to some other embodiment of the present disclosure;

FIG. 8 illustrates a partial cross-sectional view of a secondary battery according to still other embodiments of the present disclosure; and

FIG. 9 illustrates a partial cross-sectional view of a secondary battery according to still other embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

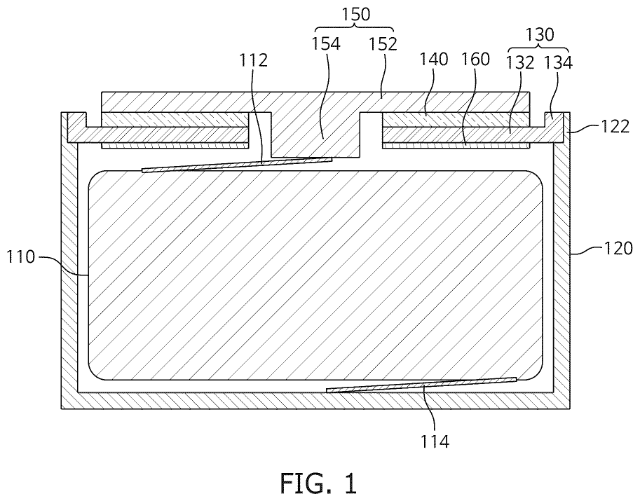

FIG. 1 illustrates a cross-sectional view of a secondary battery according to some embodiments of the present disclosure. FIG. 1 illustrates the cross-sectional view of a structure in which a secondary battery having a substantially cylindrical shape is cut in the height direction along a line crossing the center of the secondary battery. As shown, the secondary battery may include an electrode assembly 110, a case 120, and a cap assembly 130, 140, and 150.

The secondary battery may be a coin or button secondary battery. For example, the secondary battery may be column-shaped, but this is not intended to be limiting.

The electrode assembly 110 may include a first electrode, a second electrode, and a separator. For example, the electrode assembly 110 may have a wound structure in which the first electrode, the second electrode, and the separator provided between the first electrode and the second electrode are wound. The electrode assembly 110 may be wound to form a winding core, and may have a through-hole in the winding core.

The first electrode may include a first substrate and a first active material layer positioned on the first substrate. A first electrode tab 112 may extend outward from a first uncoated portion of the first substrate where the first active material layer is not provided, and the first electrode tab 112 may be electrically connected to a terminal plate 150 of the cap assembly.

The second electrode may include a second substrate and a second active material layer located on the second substrate. A second electrode tab 114 may extend outward from a second uncoated portion of the second substrate where the second active material layer is not provided, and may be electrically connected to the inner surface of the bottom of the case 120. The first electrode tab 112 and the second electrode tab 114 may extend in opposite directions from the first electrode and the second electrode, respectively.

In some embodiments, each of the first electrode tab 112 and the second electrode tab 114 may be covered with a cover tape. The cover tape may include an insulating material. In such examples, the insulating material may provide electrical insulation to prevent or substantially reduce the transmission of current. The cover tape may prevent or substantially reduce the likelihood of a short circuit that would otherwise occur between the first electrode tab 112, the second electrode tab 114, and surrounding conductive components.

The first electrode may function as a positive electrode. In such examples, the first substrate may include, for example, an aluminum (Al) foil, and the first active material layer may include, for example, a transition metal oxide. The second electrode may function as a negative electrode. In such examples, the second substrate may include, for example, a copper foil or a nickel foil, and the second active material layer may include, for example, graphite.

The separator may function to prevent the first and second electrodes from short circuiting while allowing lithium ions to migrate. The separator may include, for example, but is not limited to, a polyethylene film, a polypropylene film, a polyethylene-polypropylene film, or the like.

Referring to FIG. 1, the first electrode tab 112 of the first electrode may be provided on a first side of the electrode assembly 110. The second electrode tab 114 of the second electrode may be provided on a second side of the electrode assembly 110. However, this is not intended to be limiting, and the first electrode tab and the second electrode tab may be provided on the first side of the electrode assembly 110.

The case 120 may contain the electrode assembly 110 and electrolyte which, together with the cap assembly 130, 140, and 150 form the exterior of the secondary battery. The case 120 may include a substantially cylindrical sidewall and a bottom connected to a first side of the sidewall. However, the shape or structure of the case 120 is not limited thereto, and may have a variety of suitable shapes, including a circular shape, a pouch, or the like. In addition, the case may include a metal, such as aluminum (Al), an Al alloy, stainless steel, nickel (Ni) plated steel, a laminated film or plastic of which a pouch is made, or the like.

The case 120 may contain the electrode assembly 110. The electrode assembly 110 may be inserted into the case 120 through an open area provided in a first side of the case 120. The open area of the case 120 may then be closed (or sealed) with the cap assembly. The cap assembly may be coupled to the first side of the case 120.

The cap assembly may include the cap plate 130, an insulating layer 140, and the terminal plate 150. Herein, the cap plate 130 may cover an open area of the case 120. The cap plate 130 may be coupled to a side surface of the case 120 corresponding to a side surface of the open area.

The cap plate 130 may include a central portion 132 and a peripheral portion (e.g., outer portion) 134 provided on the periphery of the central portion 132 to be coupled to the first side of the case 120. The thickness of the peripheral portion 134 may be greater than the thickness of the central portion 132. For example, the peripheral portion 134 may be formed by folding a portion of the cap plate 130. In other examples, the central portion 132 may be formed by adjusting the thickness of a portion of the cap plate 130 in the shape of a disc having a thickness equal to the thickness of the peripheral portion 134, except for the peripheral portion 134. In such examples, the process adjusting the thickness of the portion of the cap plate 130 may be accomplished by rolling, pressing, cutting, polishing, or the like. However, the process of adjusting the thickness of the cap plate 130 is not limited thereto, and the peripheral portion 134 may be formed by various processing methods.

In some embodiments, the thickness of the peripheral portion 134 may be 1.5 times to 3 times the thickness of the central portion 132. For example, the thickness of the central portion 132 may be 50 μm to 100 μm. For example, the thickness of the peripheral portion 134 may be 150 μm to 200 μm.

The cap plate 130 may have an insertion hole provided therein. For example, the insertion hole may be provided substantially in the central portion of the cap plate 130. At least a portion of the terminal plate 150 may be inserted into the insertion hole such that the terminal plate 150 is joined to the cap plate 130. The terminal plate 150 may include a body 152 and an insertion portion 154 protruding from the body 152. Herein, the insertion portion 154 of the terminal plate 150 may be inserted into the insertion hole of the cap plate 130.

The insertion portion 154 of the terminal plate 150 may be provided on a first surface (or bottom surface) of the body 152, and a second surface of the body 152 may be opposite the first side of the body 152. Referring to FIG. 1, the terminal plate 150 may be joined to the cap plate 130 such that the insertion portion 154 faces the electrode assembly 110. In other embodiments, the terminal plate 150 and the cap plate 130 may be joined together such that the second surface of the body 152 faces the electrode assembly 110.

In some embodiments, the case 120 may have an open area provided in a first side, the open area being configured to receive the electrode assembly 110. The case 120 may include, on the first side of the case 120 where the open area is provided, a seating portion 122 having a stepped portion provided in a direction from the outer surface to the inner surface of the case 120. The peripheral portion 134 of the cap plate 130 may be seated on the seating portion 122. With the peripheral portion 134 seated on the seating portion 122, the case 120 may be connected to the cap plate 130 while firmly supporting the same.

In some embodiments, the bottom surface of the peripheral portion 134 may have a set or predetermined width to allow the peripheral portion 134 to be seated on the seating portion 122. For example, the bottom surface of the peripheral portion 134 may have a width of 100 μm or more.

The insulating layer 140 may be disposed between the terminal plate 150 and the cap plate 130. For example, the insulating layer 140 may be disposed between the body 152 of the terminal plate 150 and the central portion 132 of the cap plate 130. The insulating layer 140 may have an adhesive layer on the surface thereof to be closely attached to each of the terminal plate 150 and the cap plate 130, thereby joining the terminal plate 150 and the cap plate 130 together. The insulating layer 140 may include an insulating material to electrically insulate the terminal plate 150 and the cap plate 130 from each other.

In some embodiments, an insulating member 160 may be disposed on the bottom surface of the cap plate 130. Herein, and the bottom surface of the cap plate 130 may face the electrode assembly 110. The insulating member 160 may include an insulating material to insulate the cap plate 130 and the electrode assembly 110 from each other or the cap plate 130 and the first electrode tab 112 from each other.

Welding may be performed on the contact portions or joining portions between the cap assembly and the case 120. For example, welding may be performed on the contact or joining portions between the peripheral portion 134 of the cap plate 130 and the seating portion 122 of the case 120. In such examples, the peripheral portion 134 thicker than the central portion 132 and the first side of the case 120 may be welded, thereby relatively increasing the distance of weld regions from the electrode assembly 110 and/or the first electrode tab 112. As a result, the electrode assembly 110 and/or the first electrode tab 112 may be prevented from being damaged by the welding process. In particular, even in the case that the thickness of the central portion 132 of the cap plate 130 is reduced, sufficient weld regions may be provided in the area where the first side of the case 120 contacts the peripheral portion 134, which has a greater thickness than the central portion 132, to reduce (e.g., minimize) welding defects.

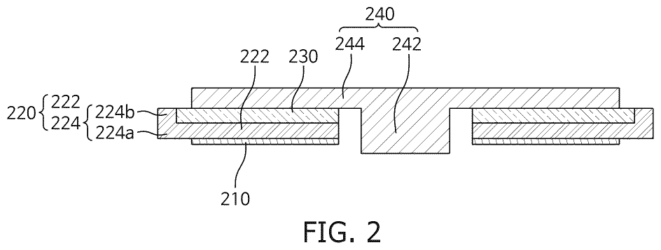

FIG. 2 illustrates a cross-sectional view of a cap assembly according to some embodiments of the present disclosure. The cap assembly shown in FIG. 2 may replace the cap assembly shown in FIG. 1. Referring to FIG. 2, the cap assembly may include an insulating member 210, a cap plate 220, an insulating layer 230, and a terminal plate 240. In the configuration of the cap assembly described with reference to FIG. 2, an insulating layer may have different features from the insulating layer 140 of FIG. 1, and the cap plate may have different features from the cap plate 130 of FIG. 1. Referring to FIG. 2, the description of features that are the same or similar to those of the cap assembly of FIG. 1 may be omitted, and features different from those of the cap assembly of FIG. 1 are primarily described.

In some embodiments, the peripheral portion 224 of the cap plate 220 may include a bend portion 224a, which is a portion of the cap plate 220 bent approximately in the height direction of the peripheral portion 224. Herein, the angle between the bend portion 224a and the central portion 222 may be about 90 degrees. In another example, the angle between the bend portion 224a and the central portion 222 may be 90 degrees or more.

In some embodiments, the peripheral portion 224 may include a protrusion 224b protruding beyond the central portion 222 in the height direction of the peripheral portion 224. In such examples, at least a portion of the insulating layer 230 may be disposed directly adjacent to the inner surface of the protrusion 224b of the cap plate. Referring to FIG. 2, at least a portion of the insulating layer 230 may be disposed on the bend portion 224a, and may be disposed next to the inner surface of the protrusion 224b.

At least a portion of the insulating layer 230 may be disposed between the cap plate 220 and the terminal plate 240. For example, at least a portion of the insulating layer 230 may be disposed between the central portion 222 of the cap plate 220 and the body 244 of the terminal plate 240.

In some embodiments, the insulating layer 230 may be disposed on at least a portion of the cap plate 220. For example, at least a portion of the insulating layer 230 may be disposed on the bend portion 224a of the cap plate 220. Referring to FIG. 2, the thickness of the peripheral portion 224 may be substantially the same as a combined thickness of the central portion 222 and the insulating layer 230.

The insulating layer 230 having the above-described configuration may prevent a short circuit between the cap plate 220 and the terminal plate 240 or substantially reduce the likelihood of occurrence thereof. For example, the insulating layer 230 may prevent foreign matter from being inserted between the cap plate 220 and the terminal plate 240, thereby preventing a short circuit. In addition, the insulating layer 230 may be configured to extend until the insulating layer 230 contacts the inner surface of the peripheral portion 224, thereby effectively preventing a short circuit between the cap plate 220 and the terminal plate 240.

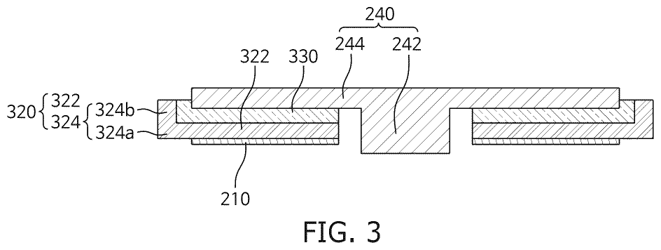

FIG. 3 illustrates a cross-sectional view of a cap assembly according to some other embodiments of the present disclosure. The cap assembly shown in FIG. 3 may replace the cap assembly shown in FIG. 1. In the configuration of the cap assembly described with reference to FIG. 3, an insulating layer may have different features from the insulating layer 140 of FIG. 1, and the cap plate may have different features from the cap plate 130 of FIG. 1. In addition, a peripheral portion 324 of the cap plate 320 may be thicker than the peripheral portion 224 of the cap plate 220 described with reference to FIG. 2. That is, a protrusion 324b of the peripheral portion 324 may be thicker than the protrusion 224b of FIG. 2. Referring to FIG. 3, the description of features that are the same or similar to those of the cap assembly of FIG. 1 or 2 may be omitted, and features different from those of the cap assemblies of FIGS. 1 and 2 are primarily described.

In some embodiments, at least a portion of the insulating layer 330 may be disposed on a bend portion 324a. In addition, at least a portion of the insulating layer 330 may be disposed directly adjacent to the inner surface of the protrusion 324b. Due to the increased thickness of the peripheral portion 324 of the cap plate 320, the insulating layer 330 may extend to be disposed next to the inner surface of the protrusion 324b. Accordingly, at least a portion of the insulating layer 330 may be disposed next to a side surface of the body 244.

The insulating layer 330 having the above-described configuration may prevent or substantially reduce the likelihood of a short circuit between the cap plate 320 and the terminal plate 240. For example, the insulating layer 330 may prevent foreign matter from being inserted between the cap plate 320 and the terminal plate 240, thereby preventing a short circuit. In addition, even in the case that the thickness of the peripheral portion 324 is greater than the thickness of the central portion 322, the insulating layer 330 may extend to be disposed between the protrusion 324b of the peripheral portion 324 and the peripheral portion of the body 244 of the terminal plate 240 to effectively prevent a short circuit between the cap plate 320 and the terminal plate 240.

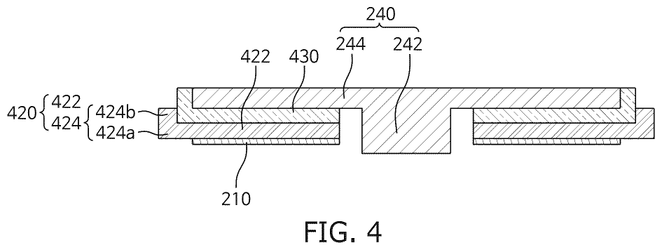

FIG. 4 illustrates a cross-sectional view of a cap assembly according to some other embodiments of the present disclosure. The cap assembly shown in FIG. 4 may replace the cap assembly shown in FIG. 1. In the configuration of the cap assembly described with reference to FIG. 4, an insulating layer may have different features from the insulating layer 140 of FIG. 1, and the cap plate may have different features from the cap plate 130 of FIG. 1. In addition, the features of the cap plate 420 of FIG. 4 may substantially the same as the features of the cap plate 220 described with reference to FIG. 2. Referring to FIG. 4, the description of features that are the same or similar to those of the cap assembly of FIG. 1 or 2 may be omitted, and features different from those of the cap assemblies of FIGS. 1 and 2 are primarily described.

In some embodiments, at least a portion of the insulating layer 430 may be disposed on the bend portion 424a. At least a portion of the insulating layer 430 may be disposed next to the inner surface of the protrusion 424b. In addition, at least a portion of the insulating layer 430 may be disposed to surround the periphery of the body 244 of the terminal plate 240.

The insulating layer 430 having the above-described configuration may prevent or substantially reduce the likelihood of a short circuit between the cap plate 420 and the terminal plate 240. For example, the insulating layer 430 may prevent foreign matter from being inserted between the cap plate 420 and the terminal plate 240, thereby preventing a short circuit. In addition, even in the case that the thickness of the peripheral portion 424 is greater than the thickness of the central portion 422, the insulating layer 430 may extend to be disposed between the protrusion 424b of the peripheral portion 424 and the peripheral portion of the body 244 of the terminal plate 240 to effectively prevent a short circuit between the cap plate 420 and the terminal plate 240.

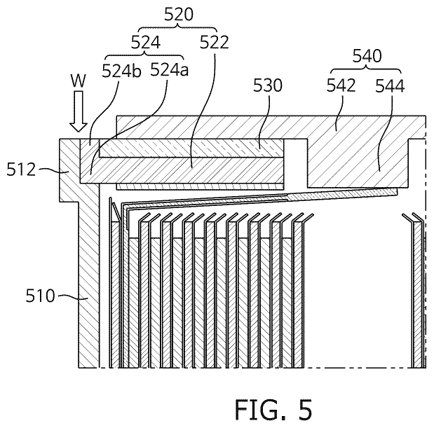

FIG. 5 illustrates a partial cross-sectional view of a secondary battery according to some embodiments of the present disclosure. In the secondary battery illustrated in FIG. 5, a cap assembly may include a cap plate 520, an insulating layer 530, and a terminal plate 540. The cap assembly may close an open area provided in a first side of the case 510.

The cap plate 520 may be joined to the terminal plate 540. In such examples, the insulating layer 530 may be disposed between the cap plate 520 and the terminal plate 540. For example, the terminal plate 540 may include a body 542 and an insertion portion 544. The insertion portion 544 of the terminal plate 540 may be inserted into an insertion hole provided in the cap plate 520. In such examples, the cap plate 520 may be joined to the terminal plate 540 such that the insertion portion 544 faces the electrode assembly.

The cap plate 520 can include a central portion 522 and a peripheral portion 524. The peripheral portion 524 may include a bend portion 524a and a protrusion 524b. In some embodiments, the peripheral portion 524 may be seated on the seating portion 512 of the case 510.

In some embodiments, welding may be performed on the contact portions or joining portions between the cap plate 520 and the case 510. For example, the cap plate 520 and the case 510 may be joined by welding the contact portions between the seating portion 512 of the case 510 and the peripheral portion 524 of the cap plate 520. Referring to FIG. 5, the welding may be performed in area W.

In some embodiments, the seating portion 512 may be formed by protruding a portion of the outer surface of the case 510 in the radial direction of the case 510. In such examples, the inner surface of the seating portion 512 may be bent in the radial direction of the case 510. The bend portion 524a of the peripheral portion 524 of the cap plate 520 may be seated on the seating portion 512. That is, the cap plate 520 and the case 510 may be joined together such that the protrusion 524b of the peripheral portion 524 faces outwardly from the case 510.

According to the above configuration, by welding the peripheral portion 524, which is thicker than the central portion 522, and the seating portion 512, which protrudes radially from the first side of the case 510, the distances of the weld regions from the electrode assembly and/or the first electrode tab accommodated in the case 510 may be relatively increased. Accordingly, the electrode assembly and/or the first electrode tab may be effectively prevented from being damaged by the welding process.

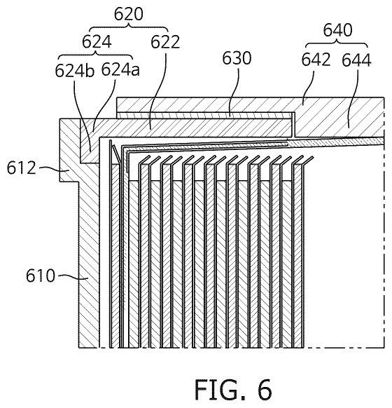

FIG. 6 illustrates a partial cross-sectional view of a secondary battery according to some other embodiments of the present disclosure. In the secondary battery illustrated in FIG. 6, a cap plate 620 may include a central portion 622 and a peripheral portion 624. The peripheral portion 624 may include a bend 624a and a protrusion 624b.

Referring to FIG. 6, the bend portion 624a of the peripheral portion 624 may be seated on the seating portion 612. That is, the cap plate 620 and the case 610 may be joined together such that the bend portion 624a of the peripheral portion 624 faces outward of the case 610. In such examples, the thickness of each of the insulating layer 630 and the terminal plate 640 joined to the cap plate 620 may be adjusted. For example, the thickness of the insulating layer 630 may be smaller than the thickness of the insulating layer 530 of FIG. 5. For example, each of the body 642 and/or the insertion portion 644 of the terminal plate 640 may be thinner than either the body 542 or the insertion portion 544 of the terminal plate 540 of FIG. 5.

According to the above configuration, by welding the peripheral portion 624, which is thicker than the central portion 622, and the seating portion 612, which protrudes radially from a first side of the case 610, the distances of the weld regions from the electrode assembly and/or the first electrode tab accommodated in the case 610 may be relatively increased. Accordingly, the electrode assembly and/or the first electrode tab may be effectively prevented from being damaged by the welding process. In addition, by setting each of the cap plate 620, the insulating layer 630, and the terminal plate 640 to have a small thickness, the space under which the electrode assembly may be accommodated may be further increased. Accordingly, the secondary battery may have increased energy density while being able to avoid a short circuit.

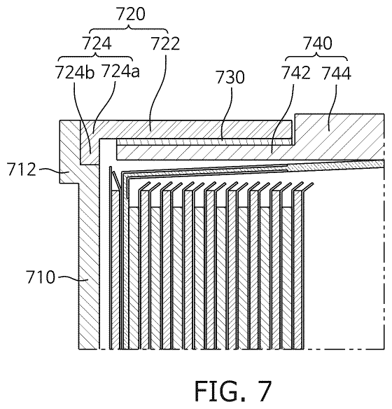

FIG. 7 illustrates a partial cross-sectional view of a secondary battery according to some other embodiments of the present disclosure. In the secondary battery illustrated in FIG. 7, a cap assembly may be coupled to a first side of the case 710 having an open area. The cap assembly may include a cap plate 720, an insulating layer 730, and a terminal plate 740.

The terminal plate 740 may include a body 742 and an insertion portion 744. For example, the terminal plate 740 may have the insertion portion 744 provided on a first surface of the body 742, and a second side of the body 742 may be opposite the first side. In addition, the terminal plate 740 may be joined to the cap plate 720 by inserting the insertion portion 744 into an insertion hole provided in the cap plate 720. The insulating layer 730 may be disposed between the cap plate 720 and the terminal plate 740. In some embodiments, the cap assembly and the case 710 may be joined together such that the second surface of the body 742 faces the electrode assembly.

The cap plate 720 may include a central portion 722 and a peripheral portion 724, wherein the peripheral portion 724 may include a bend portion 724a and a protrusion 724b. In some embodiments, the peripheral portion 724 may be seated on the seating portion 712 of the case 710. Referring to FIG. 7, the protrusion 724b may be seated on the seating portion 712 of the case 710. However, this is not intended to be limiting, and the bend portion 724a may be seated on the seating portion 712 of the case 710.

According to the above configuration, by welding the peripheral portion 724, which is thicker than the central portion 722, and the seating portion 712, which protrudes radially from the first side of the case 710, the distances of the weld regions from the electrode assembly and/or the first electrode tab accommodated in the case 710 may be relatively increased. Accordingly, the electrode assembly and/or the first electrode tab may be effectively prevented from being damaged by the welding process. In addition, by setting each of the cap plate 720, the insulating layer 730, and the terminal plate 740 to have a small thickness, the space under which the electrode assembly may be accommodated may be further increased. Accordingly, the secondary battery may have increased energy density while being able to avoid a short circuit.

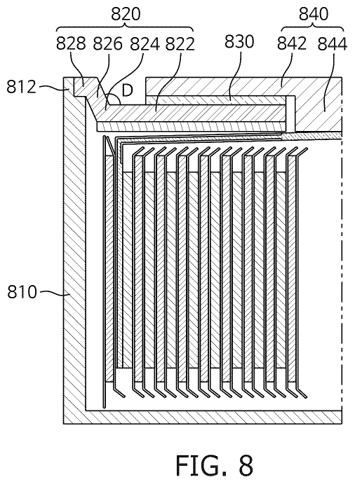

FIG. 8 illustrates a partial cross-sectional view of a secondary battery according to still other embodiments of the present disclosure. In the secondary battery illustrated in FIG. 8, a cap assembly may be coupled to a first side of the case 810 having an open area. The cap assembly may include a cap plate 820, an insulating layer 830, and a terminal plate 840.

The terminal plate 840 may include a body 842 and an insertion portion 844. For example, the terminal plate 840 may have the insertion portion 844 provided on a first surface of the body 842, and a second side of the body 842 may be opposite the first side. The insulating layer 830 may be disposed between the cap plate 820 and the terminal plate 840. In addition, the terminal plate 840 may be joined to the cap plate 820 by inserting the insertion portion 844 into an insertion hole provided in the cap plate 820.

Referring to FIG. 8, the cap assembly and the case 810 may be joined together such that the insertion portion 844 faces the electrode assembly. However, this is not intended to be limiting, and the cap assembly and the case 810 may be joined together such that the second surface of the body 842 faces the electrode assembly.

In some embodiments, the cap plate 820 may include a central portion 822 and a peripheral portion. In some embodiments, the peripheral portion may include a bend portion 824, which is a portion of the cap plate 820 bent in the height direction of the peripheral portion. Herein, the bend portion 824 may be bent at an angle D of about 90 degrees or more.

In some embodiments, the outer surface of the seating portion 812 of the case 810 may be flush with the outer surface of the case in the radial direction of the case 810. That is, the outer surface of the case 810 in which the seating portion 812 is provided may be free of curvature. In such examples, the thickness of the sidewall of the seating portion 812 may be smaller than the thickness of the sidewall of the case 810 so that a portion of the cap plate may be seated thereon.

In some embodiments, the peripheral portion may include a protrusion 826 that protrudes beyond the central portion 822 in the height direction of the peripheral portion. The peripheral portion may include a curved portion 828 formed by bending a portion of the protrusion 826 in a direction parallel to the central portion 822 of the cap plate 820. The curved portion 828 may be seated on the seating portion 812.

According to the above configuration, by welding the peripheral portions 824, 826, and 828, each of which is thicker than the central portion 822, and the seating portion 812, provided on the first side of the case 810, the distances of the weld regions from the electrode assembly and/or the first electrode tab accommodated in the case 810 may be relatively increased. Accordingly, the electrode assembly and/or the first electrode tab may be effectively prevented from being damaged by the welding process. In addition, by setting each of the cap plate 820, the insulating layer 830, and the terminal plate 840 to have a small thickness, the space under which the electrode assembly may be accommodated may be further increased. Accordingly, the secondary battery may have increased energy density while being able to avoid a short circuit. The secondary battery having the above-described configuration may also be accommodated in a limited space because the secondary battery has no outwardly protruding portion. In addition, the secondary battery may be less susceptible to damage from external objects due to the lack of protruding portions.

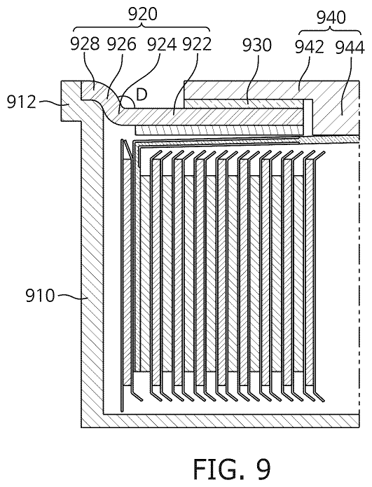

FIG. 9 illustrates a partial cross-sectional view of a secondary battery according to still other embodiments of the present disclosure. Referring to FIG. 9, the description of features that are the same or similar to those of the secondary battery of FIG. 8 may be omitted, and features different from those of the secondary battery of FIG. 1 are primarily described.

In some embodiments, a seating portion 912 of a case 910 may be formed by protruding a portion of the outer surface of the case 910 in the radial direction of the case 910. In such examples, the inner surface of the seating portion 912 may also be bent in the radial direction of the case 910. The peripheral portion of the cap plate may be seated on the seating portion 912.

In some embodiments, a cap plate 920 may include a central portion 922 and a peripheral portion. In some embodiments, the peripheral portion may include a bend portion 924, which is a portion of the cap plate 920 bent in the height direction of the peripheral portion. The peripheral portion may also include a protrusion 926 that protrudes beyond the central portion 922 in the height direction of the peripheral portion. The peripheral portion may include a curved portion 928 formed by bending a portion of the protrusion 926 in a direction parallel to the central portion 922 of the cap plate 920. The curved portion 928 may be seated on the seating portion 912.

According to the above configuration, by welding the peripheral portions 924, 926, and 928, each of which is thicker than the central portion 922, and the seating portion 912, provided on a first side of the case 910, the distances of the weld regions from the electrode assembly and/or the first electrode tab accommodated in the case 910 may be relatively increased. Accordingly, the electrode assembly and/or the first electrode tab may be effectively prevented from being damaged by the welding process.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
a case defining an open area a first side, the open area being configured to accommodate an electrode assembly;
a cap plate seated on and coupled to the open area of the case and having a through-hole;
a terminal plate configured to comprise a body and an insertion portion extending through the through-hole of the cap plate; and
an insulating layer between the cap plate and the body of the terminal plate,
wherein the cap plate comprises a central portion and a peripheral portion provided on a periphery the central portion, the peripheral portion being configured to be coupled to the first side of the case, and
wherein the peripheral portion has a greater thickness than the central portion.

2. The secondary battery as claimed in claim 1, wherein the peripheral portion comprises a bend portion which is a portion of the cap plate bent in a height direction of the peripheral portion and a protrusion extending beyond the central portion.

3. The secondary battery as claimed in claim 2, wherein a portion at which the central portion and the peripheral portion of the bend portion are connected is bent at an angle of 90 degrees or more.

4. The secondary battery as claimed in claim 1, wherein the terminal plate is joined to the cap plate such that the insertion portion faces the electrode assembly.

5. The secondary battery as claimed in claim 1, wherein the insertion portion is provided on a first surface of the body, and
wherein the terminal plate is joined to the cap plate such that a second surface of the body opposite the first surface faces the electrode assembly.

6. The secondary battery as claimed in claim 1, wherein the case comprises a seating portion on the first side of the case, the seating portion having a stepped portion provided in a direction from an outer surface to an inner surface, and
wherein the peripheral portion of the cap plate is seated on the seating portion.

7. The secondary battery as claimed in claim 6, wherein the seating portion comprises a portion of an outer surface of the case protruding in a radial direction of the case.

8. The secondary battery as claimed in claim 6, wherein the outer surface of the seating portion is flush with an outer surface of the case in a height direction of the case.

9. The secondary battery as claimed in claim 8, wherein the seating portion has a thinner sidewall than a sidewall of the case.

10. The secondary battery as claimed in claim 6, wherein the case is joined to the cap plate by welded contact portions between the case and the cap plate.

11. The secondary battery as claimed in claim 10, wherein the peripheral portion comprises a bend portion which is a portion of the cap plate bent in a height direction of the peripheral portion, and
wherein the bend portion of the peripheral portion is seated on the seating portion.

12. The secondary battery as claimed in claim 6, wherein the peripheral portion comprises a protrusion extending beyond the central portion in a height direction of the peripheral portion, and
wherein the protrusion of the peripheral portion is seated on the seating portion.

13. The secondary battery as claimed in claim 12, wherein the peripheral portion further comprises a curved portion which is a portion of the protrusion bent in a direction parallel to the central portion of the cap plate, and
wherein the curved portion of the protrusion is seated on the seating portion.

14. The secondary battery as claimed in claim 1, wherein at least a portion of the insulating layer is between the cap plate the body of the terminal plate.

15. The secondary battery as claimed in claim 14, wherein the peripheral portion comprises a bend portion which is a portion of the cap plate bent in a height direction of the peripheral portion, and
wherein at least a portion of the insulating layer is on the bend portion of the cap plate.

16. The secondary battery as claimed in claim 14, wherein the peripheral portion comprises a protrusion extending beyond the central portion in a height direction of the peripheral portion, and
wherein at least a portion of the insulating layer is next to an inner surface of the protrusion of the cap plate.

17. The secondary battery as claimed in claim 14, wherein at least a portion of the insulating layer is to surround the body of the terminal plate.

18. The secondary battery as claimed in claim 1, wherein the central portion of the cap plate has a thickness of 50 to 100 μm, and the peripheral portion has a thickness of 150 to 200 μm.

19. The secondary battery as claimed in claim 1, wherein a thickness of the peripheral portion of the cap plate is 1.5 to 3 times a thickness of the central portion.

20. The secondary battery as claimed in claim 1, wherein the peripheral portion of the cap plate has a width of 100 μm or more.
